(19) United States
(12) Patent Application Publication
(10) Pub. No.: US 2014/0101567 A1
(43) Pub. Date: Apr. 10, 2014

(54) SYSTEM, METHOD AND COMPUTER PROGRAM FOR INTERACTING WITH DATA

(71) Applicant: Smart Internet Technology CRC Pty Ltd, Eveleigh (AU)

(72) Inventors: Judith Kay, Dover Heights (AU); Catherine Locke Stewart, Pymble (AU); Anthony Eugene Collins, Burwood (AU); Christopher James Ackad, Rockdale (AU); Emma Mary Fitzgerald, Redfern (AU)

(73) Assignee: Smart Internet Technology CRC Pty Ltd, Eveleigh (AU)

(21) Appl. No.: 14/107,645

(22) Filed: Dec. 16, 2013

Related U.S. Application Data
(63) Continuation of application No. PCT/AU2012/000690, filed on Jun. 15, 2012.

(30) Foreign Application Priority Data
Jun. 17, 2011 (AU) 2011902368

(51) Int. Cl. G06F 3/0483

(52) U.S. Cl. CPC G06F 3/0483
USPC 715/748

(57) ABSTRACT

A method for a user to interact with a multi-portion document on a tabletop computing system, the method comprising the steps of providing an application arranged to display, on an interface, at least a portion of the document to the user, wherein the interface is manipulable to display a variable portion of the document.

### FIELD OF THE INVENTION

The present invention relates to a system, method and computer program for interacting with data. Embodiments of the invention find particular, but not exclusive, use in interfaces that encourage the collaboration and interaction of multiple users on an interactive computer interface, such as a tabletop interface.

### BACKGROUND OF THE INVENTION

In some computing applications it is desirable to have an interactive tabletop interface. An interactive tabletop interface allows for interaction with one or more users on a real tabletop, rather than a (virtual) desktop. An interactive tabletop interface facilitates collaborative sharing of objects such as documents, images, videos, etc., by a number of users.

Such an interface comprises a displayed image which is projected onto a tabletop. The image is displayed, for example, by use of a data projector, which projects the image onto the tabletop. One or more users can interact with the displayed image via an input of the interface, in order to, for example, manipulate objects in the displayed image. Input to the interface is provided by, for example, a touch sensitive surface, onto which the image is projected. This type of computer interface facilitates so-called “pervasive” computing.

### SUMMARY OF THE INVENTION

In a first aspect, the present invention provides a method for a user to interact with a multi-portion document on a tabletop computing system, the method comprising the steps of:
providing an application arranged to display, on an interface, at least a portion of the document to the user;
wherein the interface is manipulable to display a variable portion of the document.

In an embodiment, the method comprises the further step of, upon receipt of a command, causing at least one portion of the document to visually separate from the displayed document on the interface.

In an embodiment, the method comprises the further step of, upon receipt of a command, to cause the separated portion of the document to be stored separately from the original document.

In an embodiment, the method comprises the further step of, upon receipt of a command, causing a copy of the document to be displayed on the interface.

In an embodiment, the document and the copy of the document are linked, such that a change to the document is reflected in the copy of the document.

In an embodiment, the method comprises the further step of, upon receipt of a command, varying the orientation of the document relative to the interface.

In an embodiment, the method comprises the further step of, upon receipt of a command, displaying a copy of the document on an external interface.

In an embodiment, the method comprises the further step of, upon receipt of a command, displaying non-consecutive portions of the document.

In an embodiment, the method comprises the further step of concurrently displaying meta-data associated with the document.

In an embodiment, the method comprises the further step of, upon receipt of a command, varying the size of the document on the interface.

In an embodiment, the portion of the document is a page of a multi-page document.

In an embodiment, wherein the command for at least one of separating a portion of the document, and moving, resizing and rotating the document on the interface comprises the user performing a pre-determined motion by using at least one of a finger/stylus/mouse.

In accordance with a second aspect of the present invention there is provided a system that allows a user to interact with at least a portion of a document via a user interface, comprising:
a module arranged to display, on an interface, at least a portion of the document to the user;
wherein the interface is manipulable to display a variable portion of the document.

In accordance with a third aspect of the present invention there is provided a computer program comprising at least one instruction which, when implemented on a computer readable medium of a computer system, causes the computer system to implement the method in accordance with the first aspect of the invention.

In accordance with a fourth aspect there is provided a computer readable medium providing a computer program in accordance with the third aspect of the invention.

In accordance with a fifth aspect, there is provided a communication signal transmitted by an electronic system implementing a method in accordance with the first aspect of the invention.

In accordance with a sixth aspect, there is provided a communication signal transmitted by a computer system executing a computer program in accordance with the third aspect of the invention.

In accordance with a seventh aspect, there is provided a method for a user to interact with a multi-portion document on a tabletop computing system, the method comprising the steps of:
providing an application that is arranged to display, on a user interface, at least a portion of the document to a user;
wherein the user can input at least one command via the user interface, to manipulate the document or a portion of the document.

In an embodiment, a method in accordance with a seventh aspect, wherein upon receipt of the at least one command causing one or more of the following actions:
visually separating at least one portion of the document from the displayed document on the interface;
copying the document displayed on the user interface;
visually varying the orientation of at least a portion of the document on the user interface;

visually varying the orientation of the document on the user interface; and
displaying non-consecutive portions of the document.

In accordance with an eighth aspect, the present invention provides a system that allows a user to interact with a multi portion document, the system comprising:
a user interface; and
a module arranged to display, on the user interface at least a portion of the document;
wherein the user can input one or commands via the user interface, to manipulate the document or a portion of the document.

In an embodiment, a system in accordance with an eighth aspect, wherein upon receipt of the at least one command, causing one or more of the following actions:
visually separating at least one portion of the document from the displayed document on the interface;
copying the document displayed on the user interface;
visually varying the orientation of at least a portion of the document on the user interface;
visually varying the orientation of the document on the user interface; and
displaying non-consecutive portions of the document.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic diagram of a system for implementing an embodiment of the present invention;

FIGS. 2 to 11 are various screenshots displaying different functional elements of the Pager application in accordance with an embodiment of the invention.

### DETAILED DESCRIPTION OF AN EMBODIMENT

### Introduction

In the description which follows an embodiment of the present invention is described in the context of a tabletop computing system and a method for interacting with documents displayed on the tabletop computing system. In particular, one of the embodiments described herein will refer to the “Pager application”, a software application which provides the functionality generally described and claimed herein.

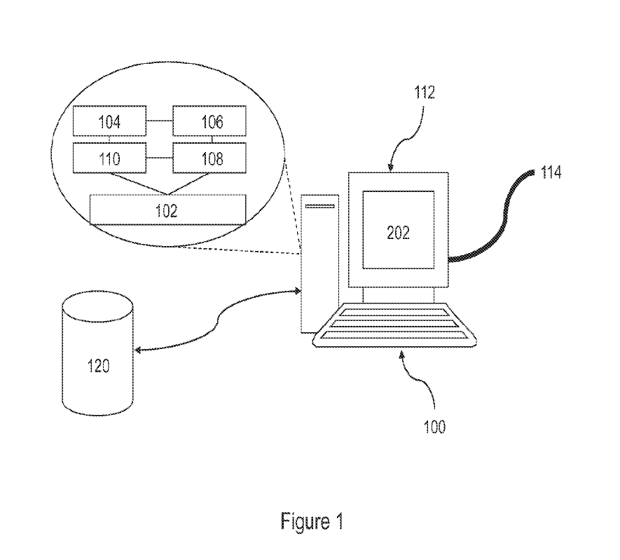

With reference to FIG. 1, there is shown a computing system in the form of a personal computer including a surface or “tabletop” touch-responsive screen display (hereafter “tabletop computer”). The tabletop computer comprises a single visual interface (i.e. the tabletop) but may be connected to multiple input devices, such as a keyboard, stylus (which allows a user to “write” on the interface), microphone or other suitable input device(s). In an embodiment, users can interact with the tabletop display using a combination of their hands, fingers, and/or a stylus. In the following description, however, the term “stylus” will be understood to include any type of physical object, such as a physical stylus pen, which allows the user to issue commands to the tabletop computer, primarily by moving the stylus and/or touching portions of the screen display with the stylus. In the embodiment described herein, the tabletop computer may also, in certain circumstances, utilise one or more keyboards. The keyboard may be “physical” keyboards (i.e. a separate hardware device which is connected to the tabletop computing environment), or they may be “virtual” keyboards (i.e. an image which is projected or displayed on the tabletop surface).

In the embodiment, the Pager application and the method implemented operates in conjunction with a proprietary “Cruiser” framework designed specifically for a tabletop computing environment. The Cruiser framework includes at least one cruiser software application operable to implement the basic functionality of the tabletop interface, such as the user interface and the standard commands utilised to manipulate objects displayed in the user interface. The Cruiser framework co-operates with the operating system to perform low level functions, such as the creation and deletion of files, folders, etc. The Cruiser framework was originally developed by Smart Internet Technology Co-operative Research Centre Pty Ltd (a private Australian company), and aspects of the Cruiser framework are the subject of other Patent Applications AU2007904925 (subsequently filed as PCT Application No. PCT/AU2008/001342); AU2007904927 (subsequently filed as PCT Application No. PCT/AU2008/001345); AU2007904928 (subsequently filed as PCT Application No. PCT/AU2008/001343); AU2007904929 (subsequently filed as PCT Application No. PCT/AU2008/001344); and AU2007231829 (subsequently filed as U.S. application Ser. No. 12/264031), which are herein incorporated by reference.

To execute the Pager application, the Cruiser application and the operating system, the tabletop computer 102 comprises computer hardware including a motherboard and central processing unit 110, random access memory 112, hard disk 114 and networking hardware 116. The tabletop touch-screen interface is denoted by the reference numeral 104. The operating system may be an operating system such as the Linux operating system, which can be obtained from the Internet at a website located at URL http:/www.redhat.com (other versions of Linux are also available such as the SUSE distribution, available at URL http://www.suse.com). The operating system resides on the hard disk and co-operates with the hardware to provide an environment in which the software applications can be executed.

In this regard, the hard disk 114 of the tabletop computer 102 is loaded with the cruiser applications (which support the Cruiser framework) in addition to the Pager application. The tabletop computer 102 also includes a communications module including standard hardware and software (such as a TCP/IP) for receiving and sending files to one or more remote computers (not shown).

With additional reference to FIG. 1, when participants utilise the tabletop computing system, they are each provided with an input device, such as a light pen 105, and their immediate interface, which they use to interact with part or all of the tabletop computing user interface 104. It will be understood that the system may also utilise a “hybrid” input system, where participants are provided with “tablet” personal computers (PCs), which are remotely or wirelessly connected to the tabletop interface. Participants can interact with the tablet PC in much the same manner as previously described herein. Such variations are within the purview of a person skilled in the art.

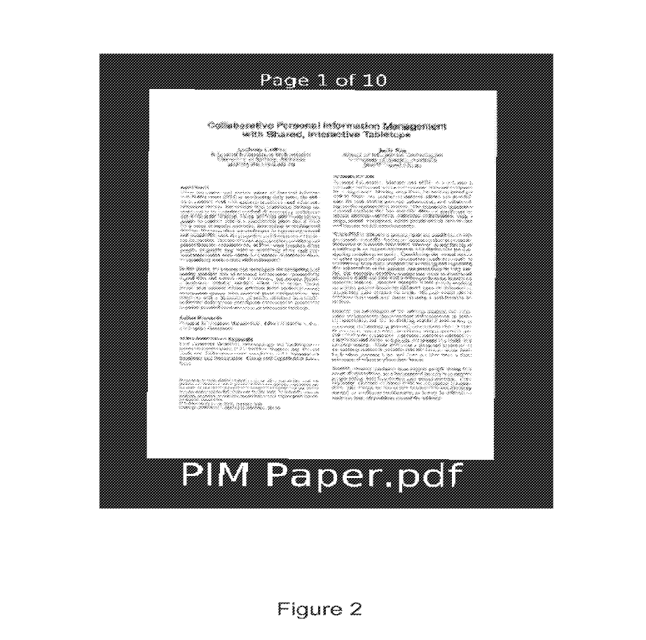

The manner in which participants (users) interact with the embodiment, namely the Pager application, is now described with reference to FIGS. 2 to 11.

Pager is a novel tabletop interface for multi-page document navigation. The features of Pager will be described hereinbelow. In addition, the specification also provides a description of how a user typically interacts with the Pager interface.

### Pager Version 1

### Sequential Pages and Meta-Data

The Pager interface allows users, in a first version (Version 1) to view one or multiple sequential pages concurrently. The single page mode also displays meta-data related to the document. The name of the document being viewed is displayed below the document and the current page number as well as the total number of pages is also displayed.

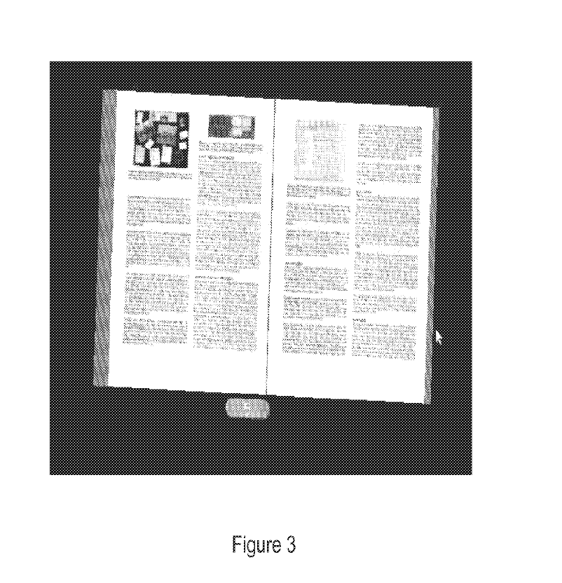

The user may choose a “one page view” (i.e. only one page is displayed) as shown in FIG. 2, or the user can expand the view to view multiple pages by double-clicking on the single page. This brings up a grey border area; users can drag this border on the right or left edge to view multiple consecutive pages simultaneously as shown in FIG. 3. When more than one page is viewed at a time, a scrollbar appears below the document. The horizontal positioning of the scrollbar indicates the relative position within the document and displays the page number of the left-most page that is currently displayed. The number of pages that can be displayed simultaneously is limited only by the display area of the tabletop.

### Move

The Pager application allows the viewed document to be moved within the tabletop display area in the same way as any other element in the Cruiser interface, which is a gesture similar to “click and drag” in a traditional computing interface (e.g. The Microsoft Windows or Apple OSX interfaces).

### Reduce/Enlarge

The document can be reduced or enlarged in size through the rosize gesture as part of the Cruiser framework.

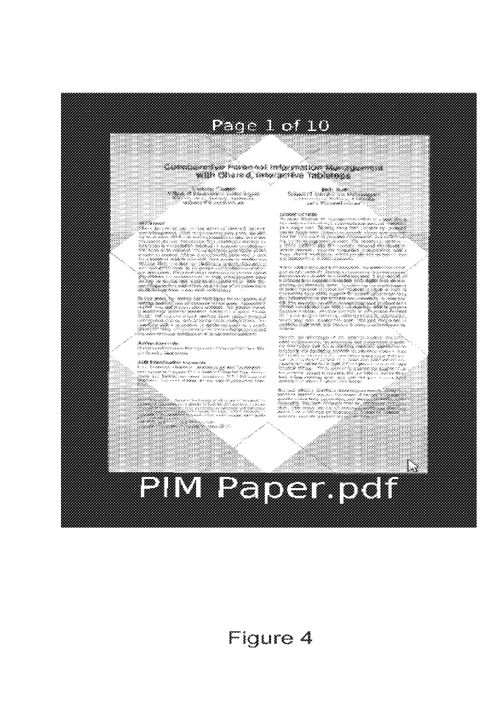

This is a composite rotate and resize gesture, which is activated when a user touches the document on one of the corners and slides their finger over the surface. The document is rotated and resized concurrently by keeping the initial point of touch beneath the user's finger, as shown in FIG. 4.

### Pinch

Users may also use a “pinching” motion to both rotate and resize the image simultaneously. That is, the user may use two or more simultaneous touch gestures, and may also combine such gestures, to effect a simultaneous rotate and resize of the image.

### Delete

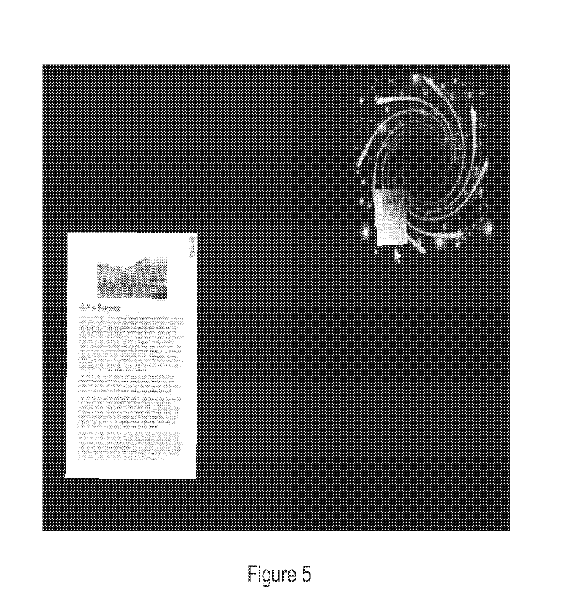

A document can be deleted from the workspace through the use of the Black Hole, a feature of Cruiser framework. Users simply move the document into the Black Hole and it is removed from the tabletop, reducing clutter for the user (see FIG. 5).

### Navigation

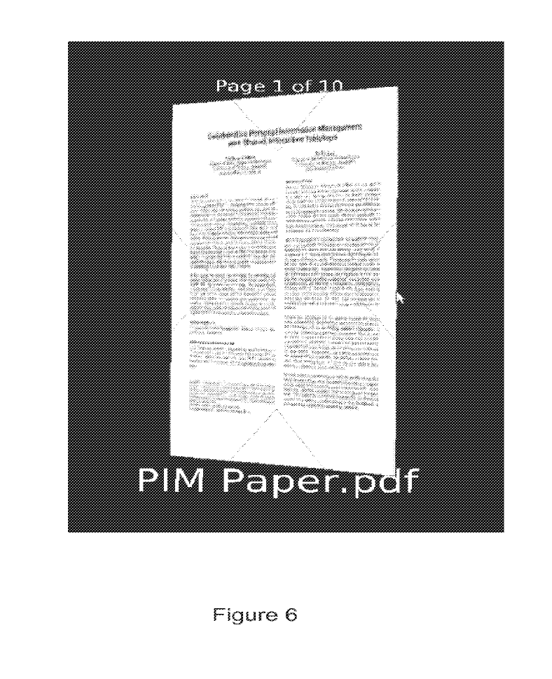

In the single page view, consecutive navigation is achieved through either a flipping gesture (see FIG. 6) or a single tap on either side of the page. A tap or flip on the right hand side of the page moves one page forward, and similarly a tap or flip on the left hand side moves one page backwards within the document.

In the multi-page view, the scrollbar provides navigation functionality. By dragging the scrollbar to the right, moves to pages which occur after the current page. Similarly, dragging the scrollbar to the left moves backwards within the document. As in the single page view, users can tap on either the right or left side of the document to move forwards or backwards (respectively) by one page.

### Follow Links

The Pager application allows users to follow links in PDF documents. This is achieved by the user touching a link, which moves the position of the document to the destination of the link. The destination is then indicated by a hand shaped icon.

### Copy

An independent copy of a document can be created. This is can be achieved by moving the document into the Copier tool as part of Cruiser, and then dragging copies out.

### Pager Version 2

Page Version 2 is a second version of Pager which has additional features. The features are discussed in more detail below.

### View

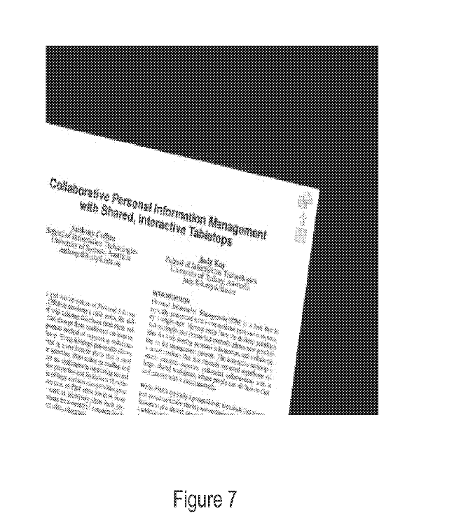

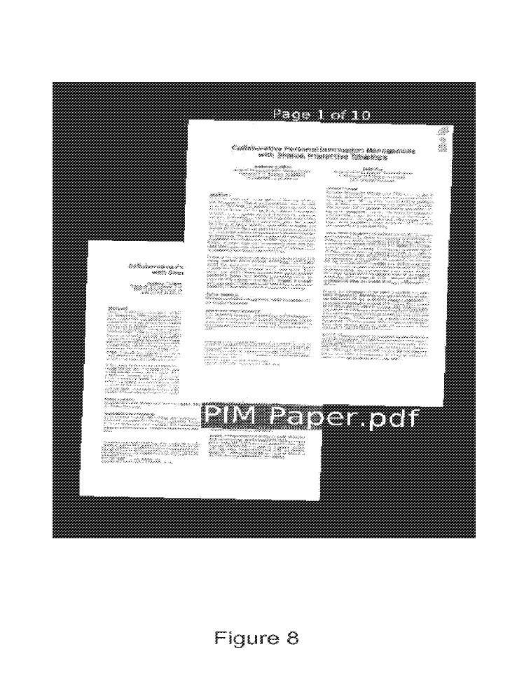

The ability to view non-sequential pages simultaneously is implemented in Pager 2 in the form of a copy button on the top-right hand corner of every page (FIG. 7). When the user taps the copy button, an independent copy of the current page subtly animates and appears over the top of the copy button (FIG. 8).

The copy button icon mimics the icon which appears on the Cruiser Copier tool, to keep consistency and encourage transfer of the users' mental model of Cruiser. The copied page can be positioned anywhere by the user, by using the move described in Pager 1. This allows users to simultaneously view non-sequential pages. Furthermore, the copied page includes all functionality of a regular document in Pager 2, such as being expanded to view multiple sequential pages. This allows the user to view non-sequential groups of consecutive pages simultaneously (FIG. 8).

### Navigation

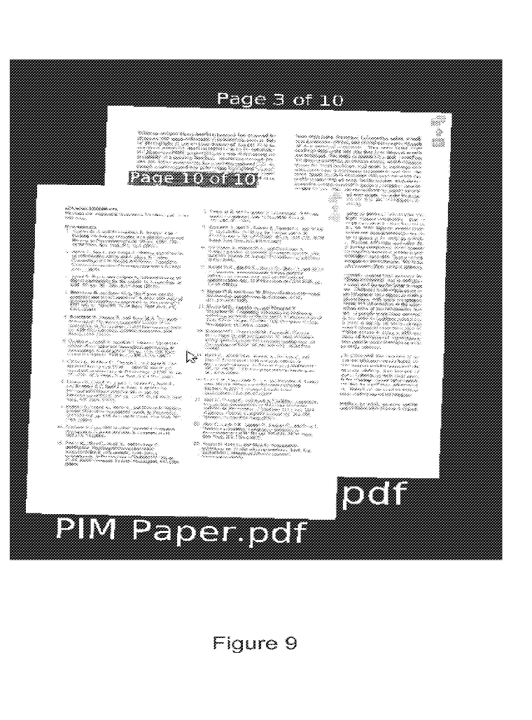

The follow link functionality in Pager 1 does not allow users to go back to the origin of the link. The go back functionality was implemented in Pager 2 by causing the destination page of the link to appear as a separate document. When a user clicks on a link on a page, the destination page appears as a separate document, positioned above and centred at the location of the link on the original document, with the original document remaining in its previous state (FIG. 9).

The follow link functionality is particularly useful in situations where intra-document links are used for reference, such as a list of citations, a glossary or a table or figure. By displaying the destination of the link as a separate document, users can easily cross-reference the two sections of the document.

The separate document which appears includes all the functionality of the original document.

### Copy

### Independent Copies

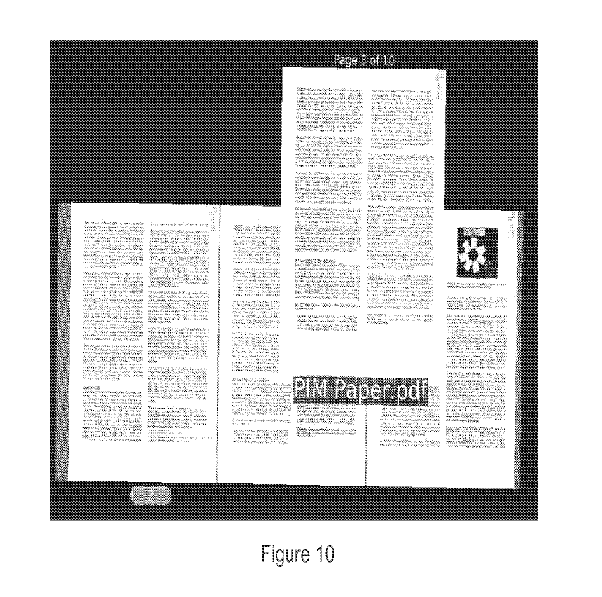

In addition to the functionality described previously, the copy button can copy any page when there are multiple pages displayed. For example, in FIG. 10, the user has selected to copy the middle page in the three page document. This copy can then be used independently of the original document and features all the functionality of the original document.

A linked copy functionality is also implemented as part of the Pager Version 2 application. A linked copy is created through the use of the Copier tool in Cruiser. A linked copy retains the intra-document page positioning as well as display format (one, two, three etc. pages at a time) of all of the documents which it is linked to. To create a linked copy, a user takes a Copier from the Cruiser toolbox and drags the single page document into the Copier. Users can then drag the document out of the Copier, creating a linked copy. If the current page is changed (i.e. a user moves forward or backwards in a document) on any linked copy, the page is changed on all the documents which it is linked to. Similarly, if a user changes the view of any document with linked copies, such as changing from a single page view to a multi-page view, or dragging out the viewable area, this action is performed on all the copies.

### Further Features

The pager interface also provides a ‘footprints’ scrollbar, to track usage of a document.

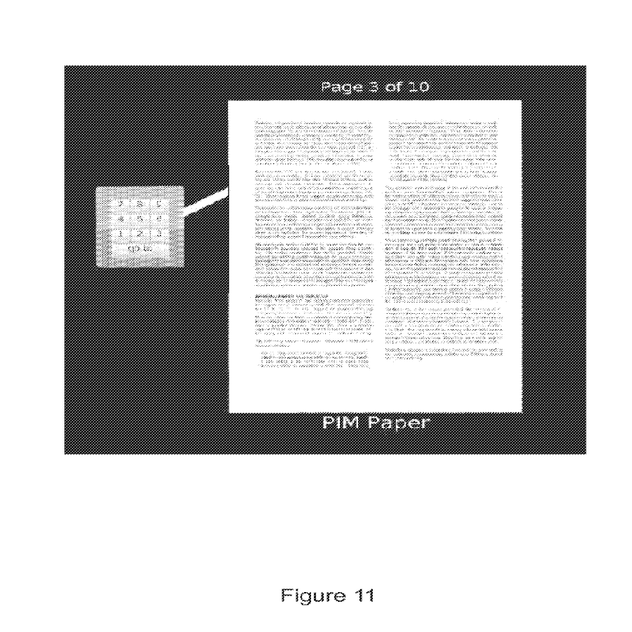

In addition, in one embodiment (not explicitly shown in the Figures), the Pager interface provides a ‘number pad’, so that a user may navigate to a specific page using the onscreen number pad, as shown in FIG. 11.

In addition, it will be understood that the ‘linked copies’ feature may be utilised across different displays and/or devices simultaneously. This allows a person to navigate a document from the tabletop, while simultaneously displaying the same document on a display (tabletop or otherwise) located elsewhere-this feature is akin to a Microsoft “PowerPoint” presentation.

In more detail, a user may activate a linked copy by “flicking” the document towards a corner of the tabletop screen. That is, by moving the document to the edge of the screen, the Cruiser framework activates an external display device, such as a projector or an external monitor, and simultaneously displays the document on both the tabletop interface and the external device. Moreover, any changes or manipulations performed on the document are mirrored on the externally displayed copy.

### Listing of Software Components

In the embodiment described herein, the application is composed of a number of disparate software components, libraries and modules, which interact with each other to provide the functionality described above. It will be understood that the components, libraries and modules described herein are illustrative of one embodiment only, and that other software applications may use different architectures, modules, components or libraries without departing from the broader invention disclosed and claimed herein.

In the preceding embodiments, reference has been made to a software application. It will be understood that the software application may be written in any appropriate computer language, and arranged to execute on any suitable computing hardware, in any configuration. The software application may be a stand-alone software application arranged to operate on a personal or server computer, or a portable device such as laptop computer, or a wireless device, such as a tablet PC or a PDA (personal digital assistant).

The software application may alternatively be an application arranged to operate on a central server or servers. The application may be accessed from any suitable remote terminal, through a public or private network, such as the Internet.

Where the software application interfaces with another computing system or a database, the data may be communicated via any suitable communication network, including the Internet, a proprietary network (e.g. a private connection between different offices of an organisation), a wireless network, such as an 802.11 standard network, or a telecommunications network (including but not limited to a telephone line, a GSM, CDMA, EDGE or 3G mobile telecommunications network, or a microwave link).

It will also be understood that the embodiments described may be implemented via or as an application programming interface (API), for use by a developer, or may be implemented as code within another software application. Generally, as software applications include routines, programs, objects, components, and data files that perform or assist in the performance of particular functions, it will be understood that a software application may be distributed across a number of routines, objects and components, but achieve the same functionality as the embodiment and the broader invention claimed herein. Such variations and modifications would be within the purview of those skilled in the art.

The foregoing description of the exemplary embodiments is provided to enable any person skilled in the art to make or use the present invention. While the invention has been described with respect to particular illustrated embodiments, various modifications to these embodiments will be readily apparent to those skilled in the art, and the generic principles defined herein may be applied to other embodiments without departing from the spirit or scope of the invention.

The present embodiments are, therefore, to be considered in all respects as illustrative and not restrictive.

A reference herein to a prior art document is not an admission that the document forms part of the common general knowledge in the art.

1. A method for a user to interact with a multi-portion document on a tabletop computing system, the method comprising the steps of:
providing an application arranged to display, on an interface, at least a portion of the document to the user;
wherein the interface is manipulable to display a variable portion of the document comprising the further step of, upon receipt of a command, causing a copy of the document to be displayed on a different device, the copy including all functionality of the document wherein the document and the copy of the document are linked, such that a change to the document or any linked copy is reflected in the linked documents.

2. A method according to claim 1 wherein the step of causing a copy of the document to be displayed on a different device is performed by moving the document towards a predefined area of the screen.

3. A method according to claim 1 wherein the step of causing a copy of the document to be displayed on a different device is performed by flicking the document.

4. A method according to claim 2 wherein the predefined area of the screen is the edge of the screen.

5. A method according to claim 2 wherein the predefined area of the screen is a corner of the screen.

6. A method in accordance with claim 1, the method comprising the further step of, upon receipt of a command, causing at least one portion of the document to visually separate from the displayed document on the interface.

7. A method in accordance with claim 6, the method comprising the further step of, upon receipt of a command, to cause the separated portion of the document to be stored separately from the original document.

8. A method in accordance with claim 1, the method comprising the further step of, upon receipt of a command, displaying non-consecutive portions of the document.

9. A method in accordance with claim 1, wherein the portion of the document is a page of a multi-page document.

10. A method in accordance with claim 6, wherein the command for at least one of separating a portion of the document, and moving, resizing and rotating the document on the interface comprises the user performing a pre-determined motion by using at least one of a finger/stylus/mouse.

11. A system that allows a user to interact with at least a portion of a document via a user interface, comprising:
a module arranged to display, on an interface, at least a portion of the document to the user;
wherein the interface is manipulable to display a variable portion of the document wherein, upon receipt of a command via the interface, the module causes a copy of the document to be displayed on a different device, the copy including all functionality of the document wherein the document and the copy of the document are linked, such that a change to the document or any linked copy of the document is reflected in the linked documents.

12. An apparatus according to claim 11 wherein the step of causing a copy of the document to be displayed on a different device is performed by moving the document to a predefined area of the screen.

13. An apparatus according to claim 11 wherein the step of causing a copy of the document to be displayed on a different device is performed by flicking the document.

14. An apparatus according to claim 12 wherein the predefined area of the screen is the edge of the screen.

15. An apparatus according to claim 12 wherein the predefined area of the screen is a corner of the screen.

16. A system in accordance with claim 11, wherein, upon receipt of a command via the interface, the module causes at least one portion of the document to visually separate from the displayed document on the interface.

17. A system in accordance with claim 16, wherein, upon receipt of a command via the interface, the module causes the separated portion of the document to be stored separately from the original document.

18. A system in accordance with claim 11, wherein, upon receipt of a command via the interface, the module displays non-consecutive portions of the document.

19. A system in accordance with claim 11, wherein the portion of the document is a page of a multi-page document.

20. A computer program comprising at least one instruction which, when implemented on a computer readable medium of a computer system, causes the computer system to implement the method in accordance with claim 1.

21. A computer readable medium providing a computer program in accordance with claim 20.

22. A communication signal transmitted by an electronic system implementing a method in accordance with claim 1.

23. A communication signal transmitted by a computer system executing a computer program in accordance with claim 21.
